(19) United States
(12) Patent Application Publication
(10) Pub. No.: US 2009/0077859 A1
(43) Pub. Date: Mar. 26, 2009

(54) FISHING LURE WITH A MOVABLE HOOK

(75) Inventor: Alonzo C. Aylsworth, Wildwood, MO (US)

Correspondence Address: CONLEY ROSE, P.C.;David A. Rose, P. O. BOX 3267, HOUSTON, TX, 77253-3267, US

(73) Assignee: ACCENT FISHING PRODUCTS, L.L.C., Chesterfield, MO (US)

(21) Appl. No.: 12/207,586

(22) Filed: Sep. 10, 2008

Related U.S. Application Data
(60) Provisional application No. 60/974,110, filed on Sep. 21, 2007.

(51) Int. Cl. A01K 85/00; B22D 19/00

(52) U.S. Cl. 43/42.39; 43/44.81; 29/527.5; 43/42.53

(57) ABSTRACT

Fishing lure with movable hook. At least some of the illustrative embodiments are fishing lures comprising a substance more dense than water, a metallic wire disposed partially within the weight member (the metallic wire defines a first eyelet and a second eyelet with both the first and second eyelets external to the weight member), and a hook member. The hook member comprises a hook eyelet hooked directly to the second eyelet, and a hook portion coupled to the hook eyelet.

### CROSS-REFERENCE TO RELATED APPLICATIONS

This application claims the benefit of provisional application Ser. No. 60/974,110 filed on Sep. 21, 2007, entitled “Fishing Lure with a Moveable Hook”, incorporated by reference as if reproduced in full below.

### BACKGROUND

Anglers, particularly professionals, are constantly searching for baits and lures that give an advantage in catching fish. The generally accepted wisdom is that any lure that mimics movement of typical fish bait (e.g. crawfish, also known as crawdads), will result in more strikes and more fish.

A second, but no less important, consideration is the ability of the fisherman to feel the strike at the lure as conveyed through the fishing line to the fishing pole. In situations where an anglar uses a crank bait, the near constant tension on the fishing line easily transfers the mechanical vibrations associated with a fish striking a lure. However, in the realm of finess baits (e.g. plastic worms), the mechanical vibrations associated with a fish striking the lure are more difficult to perceive. Thus, any lure which more realistically mimics food sources encountered by the fish, and which provides better sensitivity to strikes at the lure, is a sought after commodity by anglers.

### BRIEF DESCRIPTION OF THE DRAWINGS

For a detailed description of exemplary embodiments, reference will now be made to the accompanying drawings in which:

FIG. 1 shows a side elevation view of a fishing lure in accordance with at least some embodiments;

FIG. 2 shows a fishing lure with a skirt in accordance with at least some embodiments;

FIG. 3 shows an overhead view of a fishing lure in accordance with at least some embodiments;

FIG. 4 shows a side view of a fishing lure in accordance with at least some embodiments;

FIG. 5 shows a metallic wire and hook member disposed within a mold assembly in accordance with at least some embodiments;

FIG. 6 shows a mold assembly closed with the hook extending therefrom in accordance with at least some embodiments; and

FIG. 7 shows a method in accordance with at least some embodiments.

### NOTATION AND NOMENCLATURE

Certain terms are used throughout the following description and claims to refer to particular system components. As one skilled in the art will appreciate, fishing hardware companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect, or direct connection. Thus, if a first device couples to a second device, that connection may be through a direct connection or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

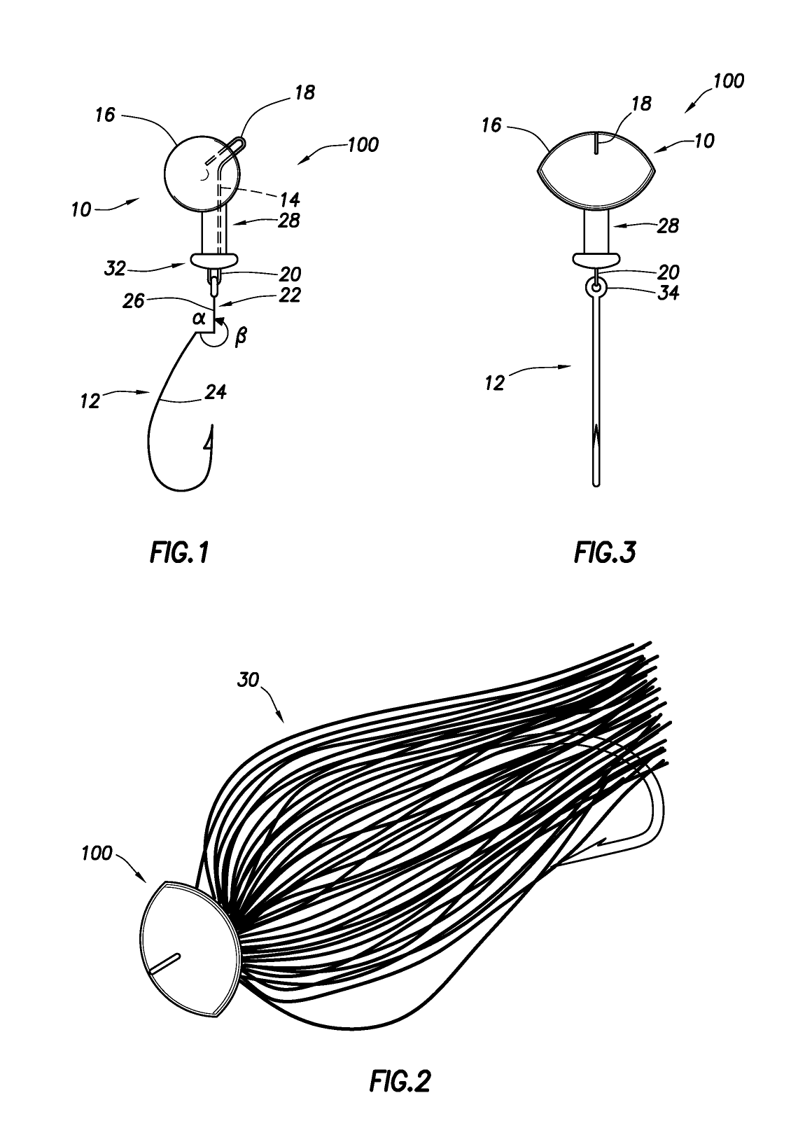

FIG. 1 shows a side elevation view of fishing lure 100 in accordance with at least some embodiments. In particular, the lure 100 comprises a weight member 10 and a hook member 12. A metallic wire 14 is disposed partially within a main body 16 of the weight member 10. Portions of the metallic wire 14 extend beyond the main body 16 to define two eyelets 18 and 20. Eyelet 18 is used as a connection point for fishing line, while eyelet 20 is used to connect directly to the hook member 12.

The hook member 12 comprises a shank portion 22 and a hook portion 24. A portion of the wire that forms the hook member 12 is bent to form a shoulder portion 26 proximate to the shank portion 22. The shoulder portion 26 and the shank portion 22 form two angles; a small angle α (alpha) and a large angle β (beta). In accordance with at least some embodiments, the small angle α is approximately 90 degrees or less. It follows that the large angle β is approximately 270 degrees or more. The purpose of the angle between the shoulder portion 26 and the shank portion 22 is to reduce the possibility of a plastic worm (or other bait coupled to the hook, such as a plastic reproduction of a crawdad) slipping off the shank onto the curved portion of the hook. Other mechanisms for maintaining a portion of the bait near the shank portion during operation may be equivalently used.

Still referring to FIG. 1, in accordance with at least some embodiments the weight member 10 further comprises an extension portion 28 that extends from the main body portion 16. In some embodiments, the extension portion 28 has a cylindrical cross-section; however, other cross-sectional shapes may be equivalently used. The extension portion 28 is a location at which a “skirt” may be fastened to the weight member 10. FIG. 2 shows the fishing lure 100 with a skirt 30 coupled to the extension portion 28. Returning to FIG. 1, in accordance with some embodiments the extension portion 28 has a uniform cross-section to the distal end, where the eyelet 20 protrudes. However, in other embodiments, the extension portion 28 has a flare 32. The purpose of the flare portion 32 is to reduce the likelihood that a skirt coupled to the extension portion 28 will slip off (toward the hook portion 12) in tight spaces, such as dense brush or rocky bottom conditions of a lake.

As shown in FIG. 1, the extension portion 28 is offset from a center of the main body portion 16. Stated more mathematically, the extension portion 28 defines a center axis, and the axis, if extended into the main body portion 16, would not intersect a center of the main body portion 16. The offset raises slightly both the skirt (if used) and the hook member 12, which reduces the possibility of dragging the skirt off the extension portion 28 and/or the bait off the hook member 12. In alternative embodiments, the extension portion may have little or no offset.

FIG. 3 shows an overhead view of the fishing lure 100 of FIG. 1. In the embodiments of FIG. 3 the weight member 10 has a “football” shape. Extending from the main body 16 is the first eyelet 18, and extending from the optional extension portion 28 is the second eyelet 20. Also shown in FIG. 3 is the hook member 12, and in particular the eyelet 34 of the hook member 12 is shown. In accordance with the various embodiments, the eyelet 34 of the hook member 12 couples directly to and/or through the eyelet 20. Stated otherwise, the eyelet 34 couples directly to the eyelet 20 of the weight member without the use of an intermediate device, such as a “split ring”. A split ring is a device similar in construction to a key ring, but on a smaller scale. As will be discussed more thoroughly below, use of a split ring decreases sensitivity to strikes as felt by the angler on the pole.

Referring to FIGS. 1 and 3 simultaneously, the eyelet 18 and eyelet 20 are formed by a single wire in accordance with the various embodiments, and the eyelets define and reside in a single plane. The eyelet 34 of the hook may also be described as defining a plane, and regardless of the position of the hook member 12 in relation to the weight member 10, the plane defined by the eyelets 18 and 20 is always substantially perpendicular to the plane defined by the eyelet 34 of the hook. Because of the relationship between the eyelet 20 and the eyelet 34, and further because a split ring is not used, the point of the point of the hook substantially always points toward the eyelet 20. Moreover, because of the arrangement the hook member is less likely to become entangled in the fishing line during casting.

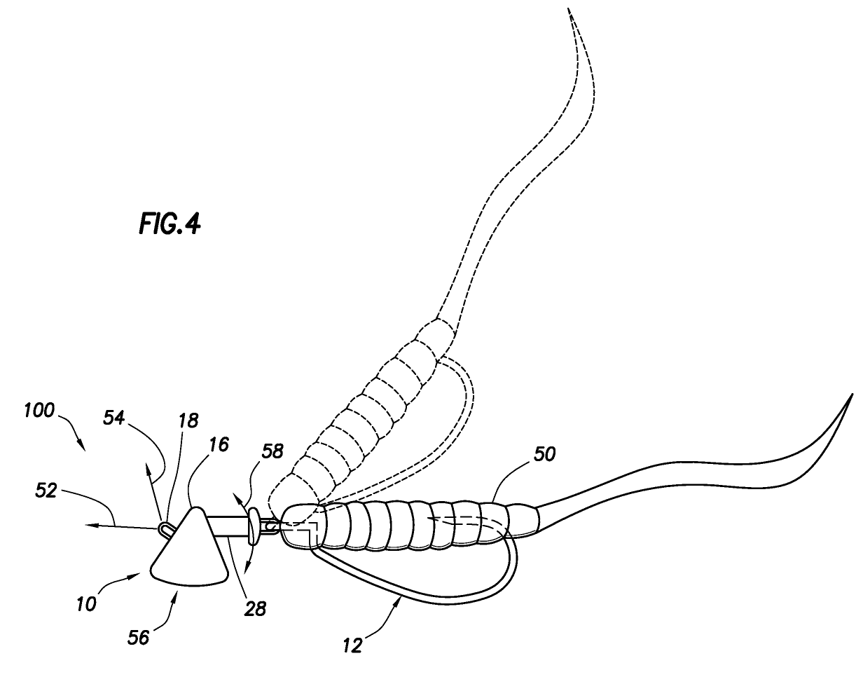

FIG. 4 illustrates fishing lure 100 in accordance with at least some embodiments. In particular, FIG. 4 illustrates that the weight member 10 need not have a “football” shape, and any shape may be equivalently used, with FIG. 4 particularly illustrating the use of a triangular or pie-shaped main body 16. FIG. 4 also illustrates the use of plastic bait, in this case a plastic worm, coupled to the hook member 12. A plastic worm 50 is merely illustrative of the type of bait that may be coupled to the hook member 12. FIG. 4 also illustrates several principles of operation of the fishing lure 100 in accordance with the various embodiments, which principles of operation may include action of the bait when the fishing lure 100 is being displaced across the bottom, as well as conveying movement to and from the lure hook member 12 and bait 50. Each will be discussed in turn.

Consider the situation where the fishing lure 100 is being horizontally translated along the lake bottom, such as by a force as indicated by arrow 52. During the horizontal translation, the force tends to push the hook member 12 and bait 50 to be in substantial alignment with the force. Stated otherwise, dragging the fishing lure 100 along the bottom tends to force the hook member 12 and the illustrative plastic worm 50 toward the bottom. However, when the force is removed (i.e., the dragging stops), the momentum of the hook member 12 and bait 50 tend to cause the hook member 12 and bait 50 to rise, as shown in dashed lines in FIG. 4. The tendency of the bait 50 to rise when the lure 100 comes to a stop may be intensified by using slightly positively buoyant bait (which helps overcome the negative buoyancy of the hook member 12). After a certain amount of time, depending on the momentum of the hook member 12 and bait 50, and depending on the buoyancy of the bait 50, the hook member 12 and bait 50 tend to settle to the orientation shown in FIG. 4 in solid lines.

The action of the bait 50 dragging behind the weight member 10, rising when the horizontal motion of the weight member 10 stops, and settling back toward an orientation where the bait 50 is laying on the lake bottom mimics the actions of a crawdad under duress. In particular, a crawdad scoots along the lake bottom by motion of its tail, and thus effectively lies flat as it moves across the lake bottom. When the crawdad stops, however, a crawdad under duress rises to a defensive position (i.e., “stands” on its tail), and eventually settles to be substantially on the lake bottom. Thus, the fishing lure 100 by design mimics the movements and defensive reactions of a crawdad, and the effects may be amplified by use of bait 50 that itself resembles a crawdad.

The specification now turns to the action of the fishing lure 100 in the absence of horizontal translation. In particular, whether the weight member 10 is in the shape of the “football” as in FIGS. 1 and 3, triangular in shape as shown in FIG. 4, or any other shape, the weight member acts as a fulcrum in transferring motion to the hook member 12. For example, consider a slight tension on the eyelet 18 as shown by arrow 54. Further consider that the slight tension in this example is not enough to raise the fishing lure 100 from the lake bottom, nor is it sufficient to induce any horizontal translation. However, in the presence of the tension 54 the bottom 56 of the weight member 10 acts as a fulcrum to translate movement to the hook member 12 as illustrated by double arrow 58. In particular, as a slight tension is applied to the eyelet 18, the eyelet of the hook member tends to be pushed toward the lake bottom. Likewise, when the tension is released the hook member tends to rise slightly. Thus, motion may be imparted to the bait 50 of the fishing lure 100 without physically raising the weight member 10 from the lake bottom. Such motion mimics, for example, a worm feeding on the lake bottom.

Still referring to FIG. 4, the motion imparted to the hook member 12 by the arrangement also works in the opposite direction. That is, any motion induced on the hook member 12 and bait 50 by a fish is more easily conveyed to the eyelet 18 and propagated along fishing line coupled to the eyelet 18. Consider, as an example, an arrangement such as FIG. 4 positioned on a lake bottom and being “struck” by a fish. In the act of striking, a fish draws the bait 50 into the fish's mouth. The drawing up of the bait 50 results in mechanical vibration imparted to the weight member 10, and with proper tension maintained on the fishing line the mechanical vibration will propagate to the rod-tip. Though an extension portion 28 is not required in all embodiments, both the mechanical vibration induced onto the hook member 12 and related bait 50, as well as the motion induced by the fish striking the bait, is amplified and intensified by the length of the extension member 28.

As shown in the various figures, the eyelet 20 couples directly to the eyelet 34 of the hook member 12. By coupling these eyelets directly together, there is no need for the use of a split ring in the coupling process. Use of a split ring between the eyelet 20 and the eyelet 34 of the hook member adds several degrees of freedom to hook movement. However, the additional degrees of freedom also create a slack mechanical coupling, and enable the hook member 12 to obtain orientations with respect to the weight member 10 that are not desirable. For example, hook members 12 coupled by way of a split ring have a greater tendency to become entangled in the fishing line during the casting process. Moreover, the additional degrees of freedom imparted by the use of the split ring desensitize the lure with respect to imparting mechanical movement to the hook member 12 and bait 50 by way of the eyelet 18, as well as imparting fish-induced movement to the fishing line and fishing pole. Stated otherwise, control over the movement of the hook member 12 and bait 50 is severely limited in the presence of a split ring, and likewise the ability of the angler to detect the minute vibrations associated with a fish drawing the hook member 12 and bait 50 into the fish's mouth is likewise lost or reduced.

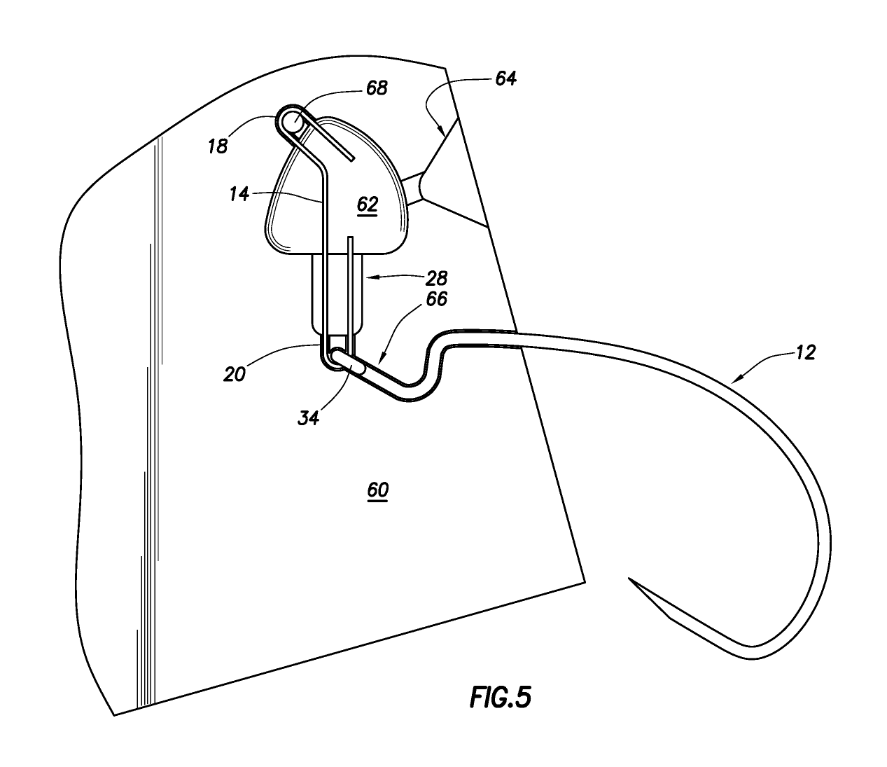

Although it is possible to couple the eyelet 34 of the hook member 12 directly to the eyelet 20 after the weight member 10 has been formed, in some embodiments the metallic wire 14 (FIG. 1) is threaded through the eyelet 34 of the hook member 12 prior to the metallic wire 14 being molded within the weight member 10. FIG. 5 illustrates molding of the fishing lure 100 in accordance with at least some embodiments. In particular, FIG. 5 illustrates the lower half of a mold 60. The mold 60 has an indention 62 being a “negative” form of the main body 16 of the weight member 10. The illustrative mold 60 also comprises an indention corresponding to the extension portion 28, but in this case the extension portion does not have the corresponding flare portion. The mold also has a fill port 64 through which the material that makes up the weight member 10 is poured or injected.

In order to mold the metallic wire into the main body portion, the metallic wire 14 is placed on the mold as illustrated in FIG. 5. Since the eyelet 34 for the hook member 12 couples directly to the eyelet 20, the metallic wire 14 may be threaded through the eyelet 34 prior to being placed in the mold 60. Because the metallic wire 14 and hook portion 12 are coupled prior to molding, the mold 60 likewise has an indention 66 to facilitate holding the hook member 12 during the pouring and molding process. In accordance with at least some embodiments, the portion of the metallic wire 14 that forms the eyelet 18 slides over a metallic pin 68, which pin 68 displaces any materials to keep them from filling the eyelet 18 aperture. A corresponding half of the mold is closed over the mold member 60 thus defining an internal cavity having the shape of weight member 10 (and in this case, extension 28). In this illustrative case the main body is triangular; however any shape (e.g., the “football”) may be equivalently used.

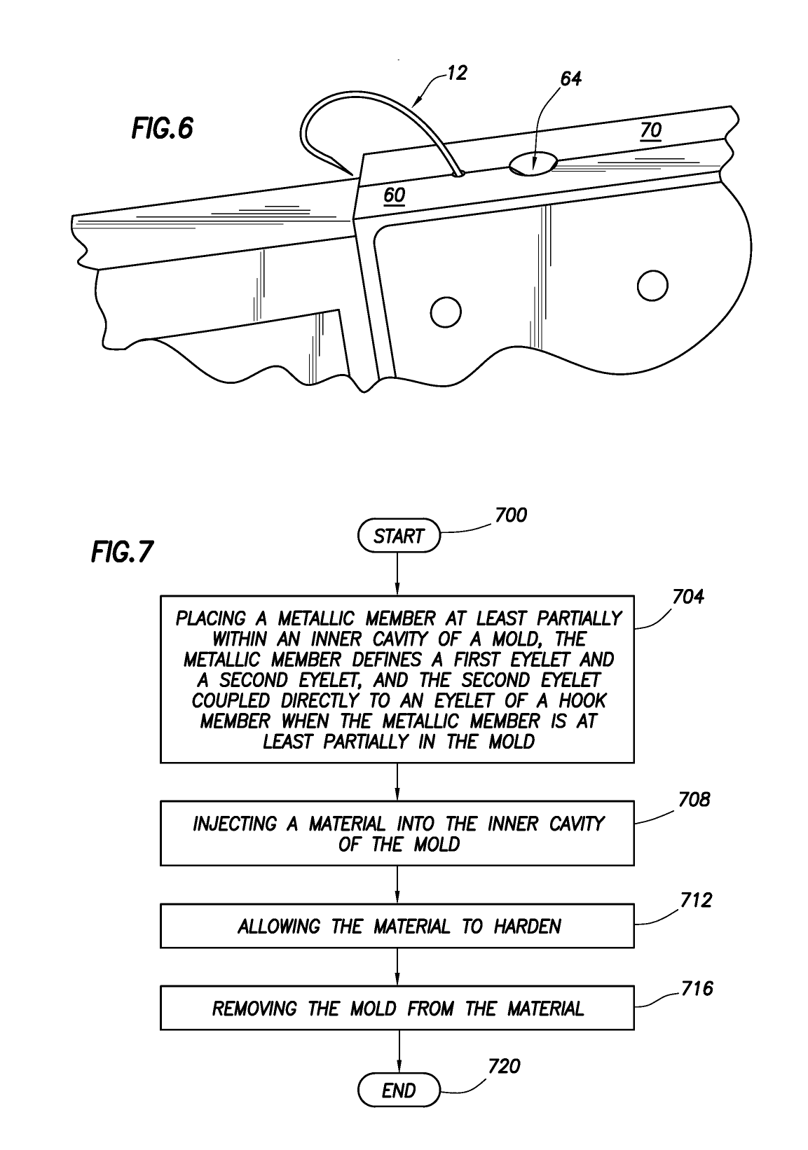

FIG. 6 shows the mold portion 60 and a mirror mold portion 70 closed together to form the internal cavity. Visible in FIG. 7 is the fill port 64, as well as a portion of the hook member 12 extending from between the mold portions 60 and 70. Once the material in the inter cavity has been injected and has hardened, the mold portions may be separated thus removing the mold from the material and exposing the rough weight member 10. The portion of the hardened material in the form of the pour point may be removed, and the weight member 10 may be polished and prepared for painting (if any).

FIG. 7 illustrates a method in accordance with at least some embodiments. In particular, the method starts (block 700). Next, the method proceeds to placing a metallic member at least partially within an inter cavity of a mold, the metallic member defines a first eyelet and a second eyelet, and the second eyelet couples directly to an eyelet of a hook member when the metallic member is at least partially within the mold (block 704). Next, a material is injected into the inner cavity of the mold (block 708) and the material is allowed to harden within the inner cavity (block 712). Next, the mold is removed from the material (block 716) and the method ends (block 720)

The above discussion is meant to be illustrative of the principles and various embodiments of the present invention. Numerous variations and modifications will become apparent to those skilled in the art once the above disclosure is fully appreciated. For example, the weight member 10 may be made of lead in most situations; however, any substance that is more dense than water and that may be molded into the proper form may be used (e.g. tungsten-based material, steel, ceramics, dense plastics). Further, the size and/or weight of the weight member 10 may vary greatly. For example, the “football” shaped main body 16 may have long dimensions from three-sixteenths of an inch to three-quarters of an inch or more, and diameters from one-eighth of an inch to half an inch or more. Likewise for the triangular shaped main body 16, the width in some embodiments may be three-eights of an inch, but larger or smaller widths may be equivalently used. Further still, the overall weight of the weight member 10 may range from a few tenths of an ounce to several ounces. Finally, the pin 68 may be a separate member inserted into the mold, or the pin 68 could be a portion of the mold remaining after milling away to form the groove for the eyelet. It is intended that the following claims be interpreted to embrace all such variations and modifications.

What is claimed is:

1. A fishing lure comprising:
a weight member comprising a substance more dense that water;
a metallic wire disposed partially within the weight member, the wire defines a first eyelet and a second eyelet with both the first and second eyelets external to the weight member;
a hook member comprising:
a hook eyelet linked directly to the second eyelet; and
a hook portion coupled to the hook eyelet, the hook portion having a single point.

2. The fishing lure of claim 1 wherein the weight member further comprises:
a main body portion;
a cylindrical portion coupled on the proximal end to the main body portion; and
the second eyelet on the distal end of the cylindrical member.

3. The fishing lure of claim 2 wherein the cylindrical member further comprises a flare on a distal end thereof.

4. The fishing lure of claim 2 further comprising:
the main body defines a circular cross section; and
the cylindrical portion defines a central axis, and the central axis does not intersect a center of the circular cross section.

5. The fishing lure of claim 1 wherein the hook member further comprises:
a shank portion coupled to the hook eyelet;
a shoulder portion that forms an angle to the shank portion;
the shank and shoulder portions form a large angle and a small angle, and the small angle being approximately 90 degrees or less.

6. The fishing lure of claim 1 wherein the first and second eyelets are co-planar, and wherein the hook eyelet defines a plane substantially perpendicular to the plane defined by the first and second eyelet.

7. The fishing lure of claim 6 wherein the hook portion defines a plane, and the plane defined by the hook portion is substantially perpendicular to the plane defined by the hook eyelet.

8. A method comprising:
placing a metallic member at least partially within an inner cavity of a mold, the metallic member defines a first eyelet and a second eyelet, and the second eyelet coupled directly to an eyelet of a hook member when the metallic member is at least partially in the mold;
injecting a material into the inner cavity of the mold;
allowing the material to harden; and
removing the mold from the material.

9. The method of claim 8 wherein placing further comprises:
placing the metallic member across an opening of a first mold form; and
placing an opening of a second mold form in mating relationship with the first mold form.

10. The method of claim 9 wherein placing the metallic member across the opening further comprises placing the first eyelet through a pin, and placing the second eyelet and the eyelet of the hook member in a depression of the first mold, the depression configured to hold the second eyelet and eyelet of the hook in place during the injecting.

11. The method of claim 8 wherein injecting further comprises injecting molten lead into the inner cavity.

12. A fishing lure comprising:
a means for inducing negative buoyancy of the lure;
a means for hooking the mouth of a fish;
a means for coupling the lure to a fishing line, and the means for coupling also for coupling the means for inducing to the means for hooking;
the fishing lure does not use a split ring to couple the means for coupling to the means for hooking.

13. The fishing lure of claim 12 wherein the means for hooking further comprises a means for maintaining a portion of a bait proximate to a shank portion of the means for hooking.

14. A fishing lure comprising:
a weight member comprising:
a main body portion;
an extension portion coupled on the proximal end to the main body portion;
the weight member comprising a substance more dense that water;
a metallic wire disposed partially within the weight member, the wire defines a first eyelet external to the weight, and a second eyelet external to the weight on a distal end of the extension portion;
a hook member comprising:
a hook eyelet linked through the second eyelet; and
a shank portion coupled to the hook eyelet;
a shoulder portion that forms an angle to the shank portion, the shank and shoulder portions form a large angle and a small angle, and the small angle being approximately 90 degrees or less;
a hook portion coupled to the hook eyelet.

15. The fishing lure of claim 14 wherein the extension portion further comprises a flare on the distal end thereof.

16. The fishing lure of claim 14 wherein the extension portion is cylindrical.

17. The fishing lure of claim 14 further comprising:
the main body defines a circular cross section; and
the extension portion defines a central axis, and the central axis does not intersect a center of the circular cross section.

18. The fishing lure of claim 14 wherein the first and second eyelets are co-planar, and wherein the hook eyelet defines a plane substantially perpendicular to the plane defined by the first and second eyelet.

19. The fishing lure of claim 18 wherein the hook portion defines a plane, and the plane defined by the hook portion is substantially perpendicular to the plane defined by the hook eyelet.
